(19) United States
(12) Patent Application Publication
(10) Pub. No.: US 2011/0108202 A1
(43) Pub. Date: May 12, 2011

(54) DEVICE FOR CONNECTING STRIPS OF WIPING MATERIAL ORIGINATING FROM AT LEAST TWO PACKAGED STACKS

(76) Inventor: Granger Maurice, Saint Priest en Jarez (FR)

(21) Appl. No.: 13/001,246

(22) PCT Filed: May 13, 2009
(86) PCT No.: PCT/FR2009/050874

§ 371 Date: Dec. 23, 2010

(30) Foreign Application Priority Data
Jun. 24, 2008 (FR) 0854167

(51) Int. Cl. B32B 37/00

(52) U.S. Cl. 156/537

(57) ABSTRACT

In a device for joining strips of wipe materials originating from at least two stacks of packaged materials, a first stack of wipe material which is in use and being used up and a spare stack of wipe material are joined to each other by a joining member placed on an exposed fold of the spare stack to face an exposed fold of the first stack. The joining member includes a component which can be detached after placing the stacks of material one on top of the other and protrudes so that it can be identified and grasped. The joining member includes an adhesive-coated part which is either protected by the detachable component or is in adhesive contact with the exposed fold of the first stack when the detachable component has been removed due to force of gravity pressing the spare stack onto the first stack.

The invention relates to the technical field of wipe materials of the general-purpose wipe, hand wipe, handkerchief and paper-towel type which are packaged in order to be dispensed by dispensing machines.

The Applicant has, for many years, developed machines for dispensing wipe materials wound on a reel which use an automatic cutting device. These machines are installed in public and private areas, hospitals, petrol stations and companies, just to mention a few examples of typical applications and to convey the object of the invention.

These machines are looked after by maintenance operatives whose job it is, in particular, to monitor the depletion of reels of materials and to fit new reels where the existing reels have nearly been used up. Although these reels of materials have a certain ability to dispense pieces of strips of materials, some machines are equipped with so-called spare reels which are substituted for the existing reel when it is nearly used up. The Applicant has thus developed many load transfer mechanisms and devices which are highly functional.

These devices make it possible, when a reel is almost used up, to superimpose and overlap the first strip of material and the strip of material from the spare reel without there being any physical joint between them. In this case, the two parts of the strips emerge from the machine one on top of the other for several revolutions of the drum of the cutting device until the service reel is totally depleted.

In practice, this solution can only be applied to wipe materials which are wound on a reel.

Where materials are folded and interleaved, as far as the Applicant is aware, there is no solution and stacks of materials of the paper-towel type cannot be continuously dispensed without manual intervention.

The same restriction applies to pre-cut wipe materials and this is why these types of wipe materials, packaged as they are, are only loaded in dispensing machines which have a small load capacity.

Confronted with this problem, the Applicant has attempted to devise a simple and efficient solution which is appropriate for accordion-pleated pre-cut wipe materials as well as folded and interleaved wipe materials.

One of the requirements was also not to damage the wipe materials loaded in the dispensing machine or, if applicable, the dispenser box.

The solution devised by the Applicant meets this requirement perfectly. It is simple, inexpensive to use, very reliable and does not cause any damage to the stack or stacks of wipe material which are in use and being used up or stacks of spare material intended to be used, without any interruption, as a substitute for a stack of material which is being used up.

According to a first aspect of the invention, the device for joining strips of wipe materials originating from at least two stacks of packaged materials is distinctive in that the stack of wipe material (P) which is in use and being used up and the spare stack of wipe material (R) are joined to each other by a joining means and in that said joining means is placed on the exposed fold of stack (R) intended to face the exposed fold of the stack which is in use and being used up (P) and in that said joining means includes a component which can be detached after placing the stacks of material (P) and (R) one on top of the other and protrudes so that it can be identified and grasped and in that the joining means includes an adhesive-coated part which is either protected by the detachable component or is in adhesive contact with the exposed fold of stack (P) when the detachable component has been removed due to the force of gravity pressing stack (R) onto stack (P).

These aspects and others will become apparent from the following description.

The object of the present invention is described, merely by way of example, in the accompanying drawings in which:

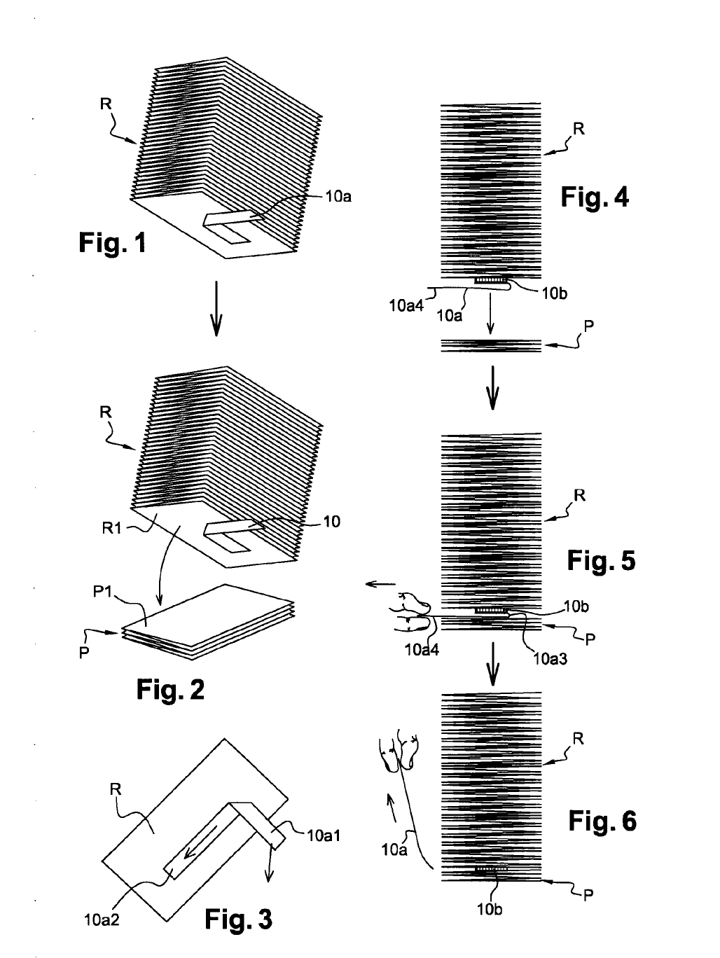

FIG. 1 shows the spare stack of pre-cut material in an arrangement which is specific to the invention prior to loading the machine.

FIG. 2 is a view according to FIG. 1 showing the joint between the stack of material which is in use and the spare stack of material.

FIG. 3 shows one embodiment of the means of joining the stack of material which is in use to the spare stack of material in one preferred implementation.

FIGS. 4, 5 and 6 are schematic views showing the various phases of presenting the spare stack of material and how it is joined to the stack of material which is in use with protrusion and then detachment of the joining means.

In order that the object of the invention may more readily be understood, the following description is given, merely by way of example, reference being made to the accompanying drawings.

The device for joining strips of wipe materials originating from at least two stacks of packaged materials is distinctive, according to the invention, in that the stack of wipe material (P) which is in use and being used up and the spare stack of wipe material (R) are joined to each other by a joining means (10). This joining means is placed on the exposed fold (R1) of stack (R) intended to face the exposed fold (P1) of the stack which is in use and being used up (P). Said joining means (10) includes a component (10a) which can be detached after placing the stacks of materials (P) and (R) one on top of the other. This joining means includes an adhesive-coated part (10b) which is either protected by the detachable component or in adhesive contact with the exposed fold of stack (P) when the detachable component has been removed due to the force of gravity pressing stack (R) onto stack (P).

Thus, each stack of packaged pre-cut accordion-pleated material or folded interleaved material is designed with its exposed fold which is capable of coming into contact and resting on a stack of material which is in use (P) comprising a special joining means (10) which has two configurations; one when the stack is being stored before being placed in the machine and another when it is being loaded in the machine. This joining means (10) is of the double-sided tape type and thus comprises an adhesive-coated part (10b) in the form of a pad which is attached to the opposite-facing face of the exposed fold (R1) of the packaged stack of (spare) material and a detachable tab (10a) which can be grasped by the operator. The shape of this tab (10a) can be identical to that of the adhesive-coated pad, as shown in FIG. 1 for example, or, preferably, be somewhat longer, as shown in FIG. 3. In this case, the tab has a part (10a2) which is attached to the adhesive-coated pad and a part (10a1) which protrudes, especially from stack (R), so that it can be visually identified and grasped by the operator. The area where this joining means (10) is located is positioned as appropriately as possible in order to facilitate removal of the tab by the operator. It is used as follows. When a dispensing machine needs to be loaded with a spare stack, the operator picks up the spare stack of material (R) which is to be loaded. He positions it on the remaining stack (P) of material which is in use and removes tab (10a) by simply pulling. In other words, removing the tab immediately causes adhesive bonding of the spare stack of material (R) which, due to its weight, presses the exposed receiving fold of joining means (10) against the exposed opposite-facing fold of the stack of material which is in use. This bonding ensures complete continuity between the two stacks of material (P) and (R).

During operation of the machine, the material can be pulled without any problem when the point at which stacks (P) and (R) are joined is reached. It is obviously preferable to position joining means (10) centrally on the packaged stack of material in order to facilitate operation of the assembly. It is also possible to envisage fitting several joining means (10) of the above-mentioned type as needs dictate.

As shown in the drawings, the bent middle part (10a3) of the tab faces in the opposite direction to the end of the tab (10a4) which protrudes and is grasped by the operator. The dimensional ratio of the length of the adhesive-coated part (10b) to the length of the tab is of the order of 1.5 to 2.5 in favour of the tab, the tab being longer so that it can protrude and be visually identified and grasped.

The invention can be applied to stacks of pre-cut folded materials as well as to stacks of interleaved materials.

1. A device for joining strips of wipe materials originating from at least two stacks of packaged materials, wherein a first stack of wipe material which is in use and being used up and a spare stack of wipe material are joined to each other by a joining member, said joining member being placed on an exposed fold of the spare stack to face an exposed fold of the first stack and said joining member including a detachable component which can be detached after placing the stacks of material one on top of the other and protrudes so that the component can be identified and grasped, and the joining member includes an adhesive-coated part which is either protected by the detachable component or is in adhesive contact with the exposed fold of the first stack when the detachable component has been removed due to force of gravity pressing the spare stack onto the first stack.

2. Device as claimed in claim 1, wherein the joining member comprises double-sided tape with an adhesive-coated part in the form of a pad which is attached to an opposite-facing face of the exposed fold of the spare stack of material and a detachable tab which protrudes from the spare stack can be grasped by an operator.

3. Device as claimed in claim 2, wherein the tab has a first part attached to the pad and a second part that protrudes from the spare stack, so that the second part can be grasped, thus allowing removal of said tab by pulling and secure bonding of the opposite-facing folds of the stacks of material.

4. Device as claimed in claim 2, wherein the tab has a bent middle part located opposite an end of the tab, the bent middle part protruding from the first stack to be grasped by the operator.

5. Device as claimed in claim 2, wherein the ratio of length of the tab to length of the adhesive-coated part in the range of 1.5 to 2.5.
